(19) United States
(12) Patent Application Publication
(10) Pub. No.: US 2012/0041885 A1
(43) Pub. Date: Feb. 16, 2012

(54) System and Method for Drafting Real-Estate Contracts

(75) Inventor: Jay P. Parker, Miami Beach, FL (US)

(73) Assignee: Simple Contracts, LLC, Miami Beach, FL (US)

(21) Appl. No.: 13/184,486

(22) Filed: Jul. 15, 2011

Related U.S. Application Data
(60) Provisional application No. 61/364,588, filed on Jul. 15, 2010.

(51) Int. Cl. G06Q 50/16

(52) U.S. Cl. 705/313

(57) ABSTRACT

A system and method prepare real-estate contracts by gather information using simple questions. Based on the answers, contract clauses are selected and added to the contract. Information such as legal description, tax information, and realtor information can be pulled from outside databases and included in the contract. Signature collection is automated and recorded. Effective dates of the contract are calculated based on the signatures. The system can export deadlines and contract information to closing agents. The result is “hard” contracts that do no fail for lack of signature, improper legal description, or being improperly filled-out.

### CROSS-REFERENCE TO RELATED APPLICATIONS

This application claims the benefit of U.S. Provisional Application No. 61/364,588, filed Jul. 15, 2011.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to systems for drafting real-estate contracts.

2. Description of the Related Art

Despite the legality, real-estate contracts are often drafted by realtors, as opposed to Attorneys. The real-estate purchase agreement involves the following steps: using a preprinted un-customized generic contract of the local board of realtors or bar association, or accessing an online website to which the realtor has subscribed, selecting a basic form from a plurality of possible forms, selecting relevant provisions from a group of commonly-used provisions, tabbing through blanks in the form and typing additional information into blanks or additional provision sections; the realtors have no formal education in this task or in the issues presented. The form selection, the provision selection, and typed information are made at the realtor's discretion and are subject to error. The forms include legalese, which can confuse non-attorneys. The forms include extra provisions that are not relevant to every transaction and lead to confusion, error, and erroneous inclusion.

Improper contract selection, inclusion or omission of provisions, and incorrect typed information leads to vulnerability, misunderstandings, difficult or impossible closings, forfeiture of deposits, and law suits.

### BRIEF SUMMARY OF THE INVENTION

The invention encompasses a system and method for drafting and executing real-estate contracts. The system is especially useful for preparing residential real-estate contracts.

An object of the invention is to simplify the residential real-estate transaction (i.e. purchase or sale) process.

A further object of the invention is to avoid confusing non-attorneys with legalese jargon that is more complex than yes/no questions.

A further object of the invention is to produce contracts that do not include clauses that are not used or are not relevant to the specific contract.

A further object of the invention is to produce real-estate contracts that do not contain errors, are fully executed, and have confirmed effective dates and firm dates for each of the relevant provisions of the contract. These confirmed effective dates contrast dates that must be calculated by interpreting contract provisions.

A further object of the invention is to provide a system that can produce a contract that can be executed on the spot so that buyers and sellers have the opportunity to make an offer immediately without returning to a realtor's office. Submitting and/or accepting an offer immediately is useful because many contracts are initiated during the excitement of seeing or showing a property. In addition, at least one, and possibly both, parties may be available during the showing so that a contract can be mutually accepted quickly and delays for signature can be avoided.

The invention encompasses a computer network accessible system to prepare real-estate contracts. The system receives information input by a user, most typically a realtor. The system then compares the information input by a user with a database of real estate legal descriptions and suggests potential matches. The user then can confirm the match, such as legal description, real-estate tax folio number. Using descriptions in the contract that match descriptions used by government agencies improves accuracy and facilitates the transfer of information throughout the closing process.

Once a legal description is identified, other information regarding the property can be pulled from databases into the contract. For example, from the legal description, real-estate tax information (i.e. folio number) can be collected. The system can prorate the real-estate tax information based on the closing date and suggest real-estate tax information for the contract. The user can confirm the real-estate tax information. In addition, the identity of property owners can be pulled from the database and used as the sellers in the contract. Lien information can be pulled from outside databases to warn realtors and buyers of potential problems as early in the process as possible.

The system pulls information from the MLS database to complete the contract. The MLS database can provide information about the realtors, brokers, and commissions as well as criteria for searching the recording office for legal descriptions.

A further object of the invention is to provide a simple, clean, minimalist user interface.

A further object of the invention is to provide a system that stores information about real estate transactions. The stored information can be used by the realtor and/or closing agent for future real-estate transactions.

A further object of the invention is to provide a printable draft contract only after the client has answered a complete set of questions. The client is not able to see or print the contract until the questionnaire is completed. This prevents customers from printing contracts that may have incorrect information. The set of questions for each contract might differ depending on the answers given by the client. Once a full set of questions have been answered, the client can see a draft contract. If the client is not satisfied, the client can request to repeat the questionnaire. If the client cannot generate a satisfactory draft contract, the system can recommend that the client contact an attorney. A default attorney can be suggested.

A further object of the invention is to provide a system that can prevent clients from manually editing a recommended contract. Many problems in draft contracts occur when non-attorneys draft their own provisions to the contract. If utilized, the system can prevent clients from overriding the safeguards.

A further object of the invention is to provide a system that collects digital signatures that are required in the real-estate transaction. The system would request information about the buyer(s) and seller(s) of property. The system then would send electronic (i.e. across a network, typically the Internet) signature requests to each of the buyers and sellers and escrow agent(s). Each buyer and seller would execute the contract and the system receives and stores the digital signatures.

Based on when the digital signatures are executed, the system will create an “effective date” of the contract. From the effective date, the contract can be released to the closing agent, buyer, seller, real-estate agents, and escrow agents to perform diligence, such as inspections, lien searches, condominium association interviews) and other closing services.

Based on the effective date, the system can create a time schedule. The time schedule can generate data that of dates and deadlines that can be exported to docketing and calendaring software. The calendar data can be in a non-proprietary or standard-based format.

The system can export contract information in formats that closing software (e.g. Displaysoft) can input the data. Direct output of data to the closing agent avoids spending time on data entry. In addition, because the information has been entered into the system from public records, the information being exported to the closing agent should be at least as accurate.

The system can include integrated closing software.

The system stores sample contract language in different languages. The user can select in which language the contract is to be written. Potential languages include, but are not limited to, the following: Spanish, Italian, and German.

The system requires and stores acknowledgment of a waiver of suggestions to seek legal counsel. In addition, the system requests and records a waiver to avoid broker liability. Such clauses are only included in comprehensive, attorney-written, non-generic contracts.

The system shall provide information to escrow agents and facilitate the collection, tracking, and return of escrow funds. The system will send a set of reminder dates for addition to the escrow agent's calendar. The system sends reminders to the buyer that the buyer's inspection period is expiring. The system gives the buyer the option to waive the inspection, cancel the contract, or demand a seller credit. The system facilitates the timely electronic transmission of this information to the seller, escrow agent, and realtors. The system of sending reminders eliminates errors in calculation and minimizes realtor liability.

In accordance with a further object of the invention, the system generates property mapping. The property mapping can be stored in the system or pulled from an external database.

The system can provide a customizable user interface to allow realtors, brokers, or other users to brand the interface. The customization can include photographs, logos, customized URLs, and other branding. The system can provide the ability to realtors to add “just sold” to online marketing materials when a contract is formed.

The system can charge users based on various billing models. Users can be billed an annual fee. Alternatively, users can be charged on a per transaction basis.

Completed contracts can be stored in the system. A fee can be periodically charged to maintain a contract in the system.

Advertising can be sold to be displayed to users. The advertising can be tailored to purchasers and sellers of real estate, realtors, real-estate brokers, insurance agents, inspection companies, and other companies who sell to purchasers and sellers of real estate.

The system includes a computerized relational database. The fields in the database include the following:

### USERID

### PASSWORD

### TRANSACTION TYPE

### REPRESENTATIVE PARTY

### BUYER NAME

### BUYER EMAIL ADDRESS

### SELLER NAME

### SELLER EMAIL ADDRESS

### ADDRESS OF PROPERTY

### PROPERTY TYPE

### PROPOSED PURCHASE PRICE

### CONSENT TO STANDARD DEPOSIT

### SPECIFIED DEPOSIT

### SPECIFIED DEPOSIT

### ESCROW AGENT IDENTITY

### ESCROW AGENT EMAIL

### AMOUNT OF CASH TO BE PAID

### AMOUNT TO BE FINANCED

### HOUSING ASSOCIATION FEES

### PARKING SPACES

### STORAGE UNITS

### CONDOMINIUM FEES

### TITLE AGENT IDENTITY

### MISCELLANEOUS PROVISIONS.

A further object of the invention is to provide a system of generating “hard” contract that cannot be avoided for error or incompleteness. The system generates hard contracts by requiring signatures, mandating fields be populated and generating reminders for dates in the diligence and closing. Such a system will eliminate contracts without effective dates and prevent miscalculation of dates.

Other features of the invention are set forth in the appended claims.

Although the invention is illustrated and described herein as embodied in a computerized system for creating real-estate contracts, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a system according to the invention.

FIG. 2 is a flowchart showing a method of creating a real estate contract according to the invention.

### DETAILED DESCRIPTION OF THE INVENTION

Embodiments of the invention are described below and are shown in the figures of the drawing.

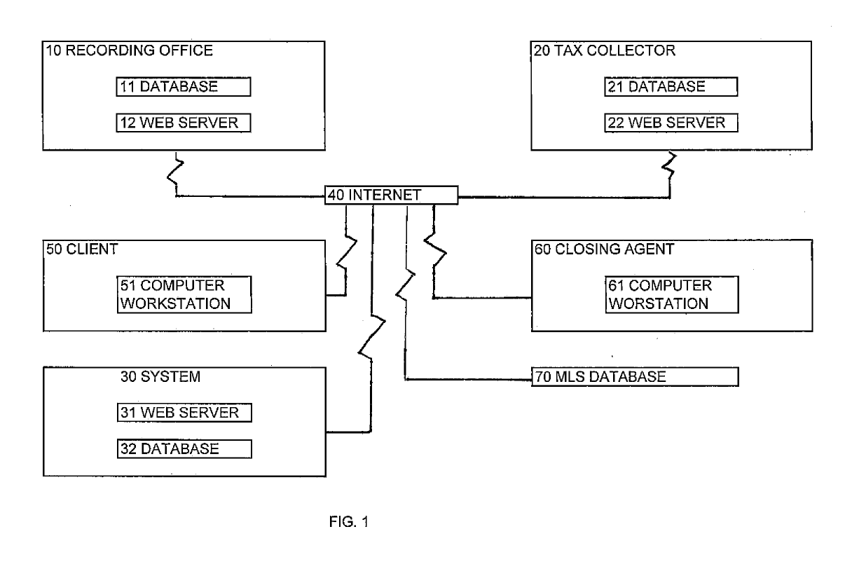

FIG. 1 shows a preferred embodiment of a system 30 for creating real-estate contracts. The system 30 includes a web server 31 and computerized database 32. The web server 31 is a computer connected to a network. The computer is capable of executing computer programs and receiving input from users. The web server 31 is connected to a computerized database 32. The computerized database 32 stores information including components of contracts, data entered for contracts, and completed contracts.

The system 30 is connected to other computers via a network, preferably, the Internet 40. The Internet 40 is a TCP/IP network.

The government (for example, the county) maintains a recording office 10. The process of recording begins when a duly executed, acknowledged, and delivered document is brought to the recording office 10 for filing in the record books in the county where the property is located. The recorder's office 10 also keeps a set of indexes containing information about each document so that the document can be discovered by a title search. A majority of states have a Grantor-Grantee Index, a set of volumes containing an alphabetical reference to the surname of the grantor followed by the name of the grantee, a brief description of the document and the property, and the location of the filed document in the official record books. The same information is contained in the “grantee-grantor index,” which is organized alphabetically by surname of the grantee. A few states use a “tract index,” which organizes all of the documents according to the location of the property. The recording office 10 is searchable online. The recording office includes a database 11 that is connected to a web server 12. The web server 12 is connected to the Internet 40.

The tax collector 20 is a government (i.e. county) officer responsible for collecting real-estate taxes. Tax appraisals and tax amounts are published online. The database 21 of tax amounts are organized by legal description of properties. The database 21 is connected to a web server 22. The web server 22 is connected to the Internet 40. The web server 22 allows users to access the database 21 via the Internet 40.

A client 50 uses a computer workstation 51 to access the system 30. The computer workstation 51 is preferably a personal computer using a web browser. The computer workstation 51 is connected to the Internet 40. The user 50 uses the computer workstation 51 to access the system 30 via the Internet 40. In a preferred embodiment, the workstation 51 is a mobile device such as those sold under the trade names IPHONE, IPAD, BLACKBERRY, ANDROID, and WINDOWS MOBILE.

A closing agent 60 is a business, preferably, a law firm or title company, that performs the diligence and title insurance, HUD preparation, recording, and fund transfers to complete a real-estate transaction. The closing agent 60 has a computer workstation 61. The computer workstation 61 is connected to the Internet 40. The computer workstation 61 is connected to the system 30 via the Internet 40. The closing agent 60 receives information about the real-estate closing from the system 30. Real estate listings are posted in an online database known as the Multiple Listing Service (i.e. MLS Database 70).

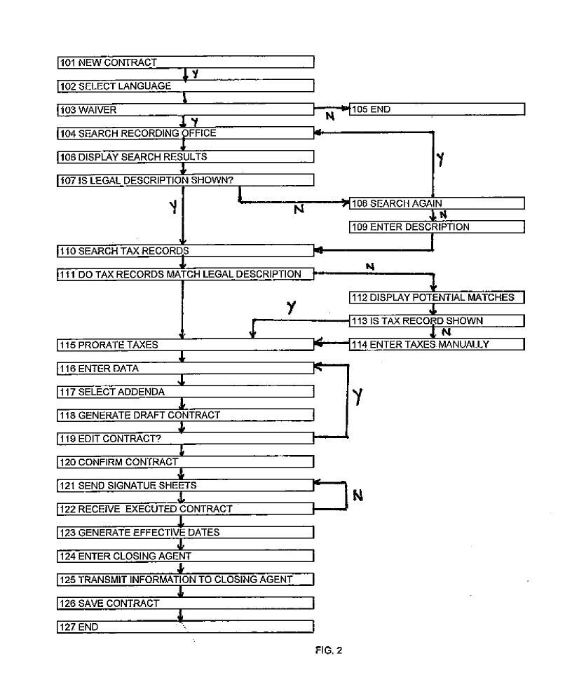

FIG. 2 is a flow chart showing a preferred embodiment of writing a real-estate contract using the system 30. A client 50 uses a workstation 51 to access the web server 31 of the system 30. The web server 31 then executes a computer program and transmits and receives information and input from the workstation 51.

In step 101, the client 50 chooses to enter a new contract or to modify an existing contract. If a new contract is selected, a new record is created in the database 32.

In step 102, the system 30 asks the client 50 to select a language for the contract.

In step 103, the system 30 asks the client 50 to complete a waiver that the client 50 has been recommended to use an attorney. A real-estate broker waiver can be included as well. The confirmation of waiver is stored in the database 32. If the client 50 refuses to complete the waiver, in step 105, the system 30 ends the program and recommends that the client 50 contacts an attorney.

In step 104, the system 30 prompts the client 50 to enter an address of the real-estate that is the res of the transaction. The system 30 then searches the recording office 10 and pulls potential matches based on the search criteria from the recording office 10 to the system 30.

In step 106, the system 30 transmits the results from the recording office 10 to the client 50. In step 107, the client 50 confirms that the proper legal description has been collected. A confirmation is transmitted from the client 50 to the system 30. If a matching record is not shown, the system 30 asks the client 50 if the client 50 desires to enter new criteria. If yes, the system returns to step 104. If no, the system 30 requests the user 50 to enter a legal description manually in step 109.

In step 110, the system 30 searches the database 21 in the tax collector 20. The search can be based on the legal description. In step 111, the system 30 confirms that a record in the database 21 matches the legal description. If no match exists, the system 30 displays to the client 50 potential matching records. In step 113, the client 50 selects a matching record if one exists. If no matches exist, the client 50 is given the opportunity to enter tax information manually. The tax collector 20 transmits to the system 30 the estimated taxes, tax appraisal information, last tax payment date, and the existence of any tax liens.

In step 115, the system 30 prorates the taxes based on the tax information and the estimated closing date.

In step 116, the client enters data regarding the transaction. Information that can be entered includes, but is not limited to, the following: userid, password, transaction type, representative party, buyer name, buyer email address, seller name, seller email address, address of property, property type, proposed purchase price, consent to standard deposit, specified deposit specified deposit, escrow agent identity, escrow agent email, amount of cash to be paid, amount to be financed, housing association fees, parking spaces, storage units, condominium fees, title agent identity, and miscellaneous provisions. The system 30 can pull information from the MLS database 70. The MLS database 70 includes data for a given property including realtor numbers, broker numbers, and realtor commissions. The seller information can be taken from the recording office 10. All information taken from outside databases can be confirmed by the client 50.

In step 117, the client 50 is prompted to determine which addenda need to be added to the contract. The system 30 can prompt the client 50 with simple or even yes/no questions to gather what addenda need to be included.

In step 124, the client 50 specifies a closing agent. A default closing agent can be automatically entered. In addition, the client 50 specifies an escrow agent. A default escrow agent can be automatically entered.

In step 118, the system 30 generates a draft contract based on the collected data, the entered data, and the answers to the questionnaire. The contract is built from prewritten clauses that are stored within the database 32.

In step 119, the system 30 displays an unmodifiable electronic version (e.g. a Portable Document Format or *.PDF) of the draft contract to the client 50. After reviewing, the client 50 is asked to edit the contract, which would result in the client 50 being asked to edit the answers to the preliminary questions. The client 50 can be returned to step 116 to correct or reenter data. In step 120, the client 50 confirms the draft contract.

In step 121, the system 30 transmits signature sheets to the buyers and once electronically signed by the buyers, the system 30 transmits the executed offer to the sellers. Once the contract is executed by both the buyer and seller, the system 30 emails the now fully executed contract to the designated escrow agent and/or closing agent for processing. The signature sheets include instructions and software that comply with electronic and/or pen-and-ink signature requirement. The system 30 collects and stores the signed contracts.

In step 123, the system 30 generates an effective date of the contract based on the signatures. From the effective date, the system creates calendar dates for deadlines in the transaction. For example, the system 30 generates closing dates, inspection dates, finance deadlines, etc. The calendar dates are generated in standard format, for example, Microsoft Outlook format, and transmits the calendar events to the parties, agents, and closing agent.

In step 125, all of the information regarding the contract is forwarded to the closing agent 51. The data can be in a format that is compatible with a given closing software such as those sold under the trade names LANDTECH and DISPLAYSOFT.

In step 126, the system 30 saves in the database 32 the contract, signatures, and all related data.

Unless otherwise mentioned the reference numbers are used consistently throughout the figures.

What is claimed is:

1. A system for drafting real-estate contract, comprising:
a computer server storing contract clauses, said computer server executing a computer program for requesting contract information from a client; said computer server selecting contract clauses based on the contract information.

2. The system according to claim 1, wherein said computer server retrieves contract information from a government recording office.

3. The system according to claim 1, further comprising a client computer, wherein said client computer is a handheld device.

4. A method of creating real-estate contract, which comprises:
providing a plurality of real-estate contract clauses;
asking questions of a client that identify when each of the real-estate contract clauses is to be included or to be excluded; and
selecting real-estate contract clauses from said plurality based on the contract information to form a real-estate contract.

5. The method according to claim 4, which further comprises sending said real-estate contract to buyers and sellers for electronic signature.

6. The method according to claim 5, which further comprises calculating an effective date of the contract based on the electronic signatures.

7. The method according to claim 4, which further comprises gathering real-estate information from a third-party database.

8. The method according to claim 7, wherein said third-party database is selected from the group consisting of a government recording office, a tax collector, and a real-estate listing database.

9. The method according to claim 4, which further comprises not asking the client directly to include or exclude at least one of the real-estate contract clauses.

10. The method according to claim 6, which further comprises calculating real-estate transaction deadlines based on the effective date.

11. The method according to claim 4, which further comprises only generating a printable contract after a given set of questions has been completed.
